(19) United States
(12) Patent Application Publication
(10) Pub. No.: US 2026/0301305 A1
(43) Pub. Date: Oct. 1, 2026

(54) DECOUPLED RAY TRAVERSAL POPULATION USING RAY QUEUES

(71) Applicant: Advanced Micro Devices, Inc., Santa Clara, CA (US)

(72) Inventors: Michael John Livesley, Cambridge (GB); Sean Keely, Santa Clara, CA (US); David Ronald Oldcorn, Cambridge (GB); Daniel James Skinner, Cambridge (GB)

(73) Assignee: Advanced Micro Devices, Inc., Santa Clara, CA (US)

(21) Appl. No.: 19/090,287

(22) Filed: Mar. 25, 2025

(51) Int. Cl. G06T 15/06; G06T 15/00

(52) U.S. Cl. CPC G06T 15/06; G06T 15/005; G06T 2210/21; G06T 2210/52

(57) ABSTRACT

In ray tracing hardware, dedicated circuitry is often used to traverse a bounding volume hierarchy. This dedicated hardware has an internal memory that stores state for rays for which such traversal is being performed. If this internal memory becomes full with outstanding rays, the dedicated hardware may become starved of work. For this reason, techniques are provided to “overflow” rays from this internal memory a hit buffer. Slots in the hit buffer can be used for two different purposes—to store information about detected hits, as well as to store working state for rays outstanding in the dedicated intersection hardware. If this dedicated hardware receives work that does not fit in its internal memory, the dedicated intersection hardware stores such work into the hit buffer. When slots become free in the internal memory, the intersection hardware retrieves such work from the hit buffer for processing.

### BACKGROUND

Ray tracing is a technique has the capability to produce highly realistic images. However, this technique can be very computationally demanding. Techniques for improving ray tracing are constantly being developed.

### BRIEF DESCRIPTION OF THE DRAWINGS

A more detailed understanding can be had from the following description, given by way of example in conjunction with the accompanying drawings wherein:

FIG. 1 is a block diagram of an example device in which one or more features of the disclosure can be implemented;

FIG. 2 is a block diagram of aspects of device, illustrating additional details related to execution of processing tasks on the APD;

FIG. 3 illustrates a ray tracing pipeline for rendering graphics using a ray tracing technique, according to an example;

FIG. 4 is an illustration of a bounding volume hierarchy, according to an example;

FIG. 5 is a block diagram of a system for performing ray tracing, according to an example;

FIG. 6 is an illustration of a hit buffer, according to an example;

FIGS. 7-9 illustrate example operations for utilizing the hit buffer to overflow ray data; and

FIG. 10 is a flow diagram of a method for performing ray tracing work, according to an example.

### DETAILED DESCRIPTION

Ray tracing is a technique capable of rendering highly realistic images by following the path of simulated light rays through a scene. While capable of generating highly realistic images, ray tracing is highly processing intensive.

For each ray, ray tracing involves performing a search through the geometry of the scene to identify intersections between the ray and primitives in the scene. A data structure referred to as an acceleration structure (an example of which is a bounding volume hierarchy) improves the speed with which this search occurs. In ray tracing hardware, it is frequently the case that dedicated hardware circuitry is used to traverse the bounding volume hierarchy. This dedicated hardware has an internal memory that stores state for rays for which such traversal is being performed. If this internal memory becomes full with outstanding rays, the dedicated hardware may become starved of work. In one example, there is significant latency in getting a new ray from a shader core when a ray has completed. For example, it takes time for such completion to be communicated to the shader core and for the shader core to react to the communication, and the wave waiting to trace rays may be asleep and not selected for execution for some time. Additionally, the granularity required to get that wave to issue rays is set by the number of active lanes: if 32 lanes (for example) want to trace rays, then 32 slots are needed in the ray memory in the traversal units to issue that wave and pass the rays for tracing. If there are only 31 free slots, then the wave cannot be issued, which starves the traversal unit of work. In another example, mid-traversal shading leaves rays in the traversal unit while such mid-traversal shading is being performed, which means that the space in the traversal unit is not utilized for other rays.

For this reason, techniques are provided to “overflow” rays, either directly from this internal memory, or rays received from an external unit, into an external memory already present for a different purpose—the hit buffer. This hit buffer stores information about hits detected by the dedicated hardware. Slots in the hit buffer can be used for two different purposes—to store such information about detected hits, as well as to store working state for rays outstanding in the dedicated intersection hardware. If this dedicated hardware receives work that does not fit in its internal memory, the dedicated intersection hardware stores such work into the hit buffer. When slots become free in the internal memory, the intersection hardware retrieves such work from the hit buffer for processing (e.g., BVH traversal). These techniques solve the above issues, by allowing the traversal unit to feed work to itself without needing to wait for the various latencies described elsewhere herein.

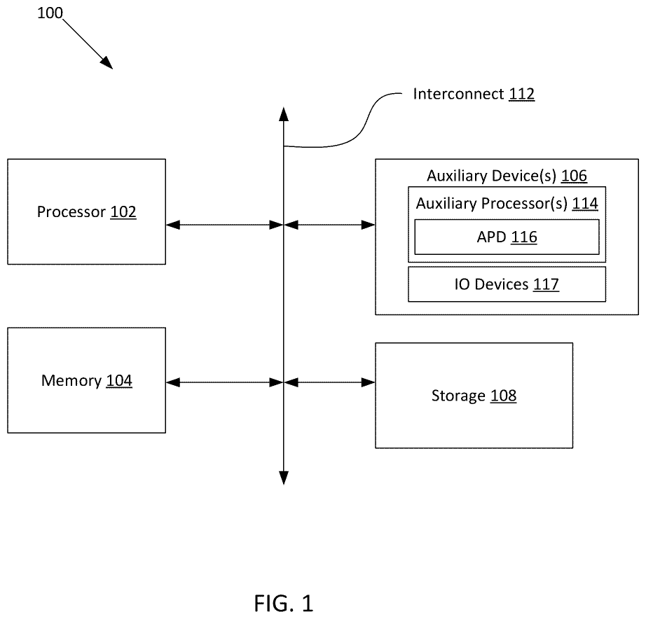

FIG. 1 is a block diagram of an example computing device 100 in which one or more features of the disclosure can be implemented. In various examples, the computing device 100 is one of, but is not limited to, for example, a computer, a gaming device, a handheld device, a set-top box, a television, a mobile phone, a tablet computer, or other computing device. The device 100 includes, without limitation, one or more processors 102, a memory 104, one or more auxiliary devices 106, and a storage 108. An interconnect 112, which can be a bus, a combination of buses, and/or any other communication component, communicatively links the one or more processors 102, the memory 104, the one or more auxiliary devices 106, and the storage 108.

In various alternatives, the one or more processors 102 include a central processing unit (CPU), a graphics processing unit (GPU), a CPU and GPU located on the same die, or one or more processor cores, wherein each processor core can be a CPU, a GPU, or a neural processor. In various alternatives, at least part of the memory 104 is located on the same die as one or more of the one or more processors 102, such as on the same chip or in an interposer arrangement, and/or at least part of the memory 104 is located separately from the one or more processors 102. The memory 104 includes a volatile or non-volatile memory, for example, random access memory (RAM), dynamic RAM, or a cache.

The storage 108 includes a fixed or removable storage, for example, without limitation, a hard disk drive, a solid state drive, an optical disk, or a flash drive. The one or more auxiliary devices 106 include, without limitation, one or more auxiliary processors 114, and/or one or more input/output (“IO”) devices. The auxiliary processors 114 include, without limitation, a processing unit capable of executing instructions, such as a central processing unit, graphics processing unit, parallel processing unit capable of performing compute shader operations in a single-instruction-multiple-data form, multimedia accelerators such as video encoding or decoding accelerators, or any other processor. Any auxiliary processor 114 is implementable as a programmable processor that executes instructions, a fixed function processor that processes data according to fixed hardware circuitry, a combination thereof, or any other type of processor.

The one or more auxiliary devices 106 includes an accelerated processing device (“APD”) 116. The APD 116 may be coupled to a display device, which, in some examples, is a physical display device or a simulated device that uses a remote display protocol to show output. The APD 116 is configured to accept compute commands and/or graphics rendering commands from processor 102, to process those compute and graphics rendering commands, and, in some implementations, to provide pixel output to a display device for display. As described in further detail below, the APD 116 includes one or more parallel processing units configured to perform computations in accordance with, for example, a single-instruction-multiple-data (“SIMD”) or a single-instruction-multiple-thread (“SIMT”) paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and, optionally, configured to provide graphical output to a display device. For example, it is contemplated that any processing system that performs processing tasks in accordance with a SIMD paradigm may be configured to perform the functionality described herein. Alternatively, it is contemplated that computing systems that do not perform processing tasks in accordance with a SIMD paradigm perform the functionality described herein.

The one or more IO devices 117 include one or more input devices, such as a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals), and/or one or more output devices such as a display device, a speaker, a printer, a haptic feedback device, one or more lights, an antenna, or a network connection (e.g., a wireless local area network card for transmission and/or reception of wireless IEEE 802 signals).

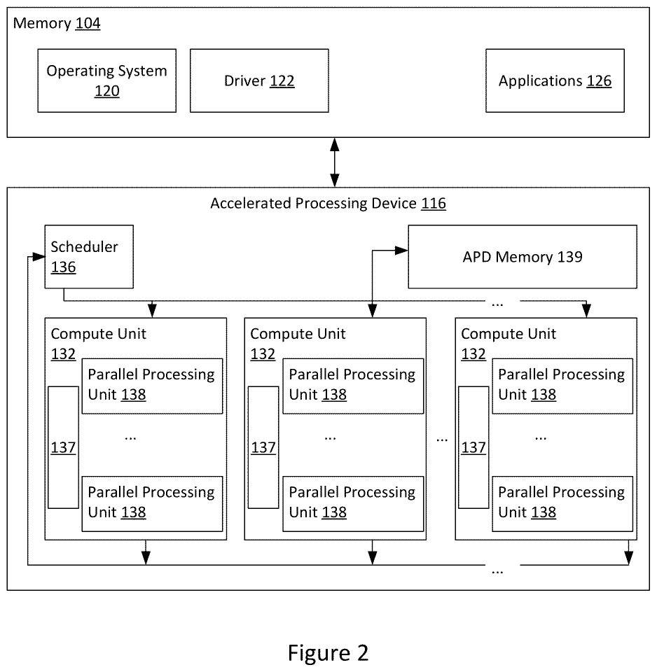

FIG. 2 is a block diagram of aspects of device 100, illustrating additional details related to execution of processing tasks on the APD 116. The processor 102 maintains, in system memory 104, one or more control logic modules for execution by the processor 102. The control logic modules include an operating system 120, a kernel mode driver 122, and applications 126. These control logic modules control various features of the operation of the processor 102 and the APD 116. For example, the operating system 120 directly communicates with hardware and provides an interface to the hardware for other software executing on the processor 102. The kernel mode driver 122 controls operation of the APD 116 by, for example, providing an application programming interface (“API”) to software (e.g., applications 126) executing on the processor 102 to access various functionality of the APD 116. The kernel mode driver 122 also includes a just-in-time compiler that compiles programs for execution by processing components (such as the parallel processing units 138 discussed in further detail below) of the APD 116.

The APD 116 executes commands and programs for selected functions, such as graphics operations and non-graphics operations that are or can be suited for parallel processing. The APD 116 can be used for executing graphics pipeline operations such as pixel operations, geometric computations, and rendering an image to display device 118 based on commands received from the processor 102. The APD 116 also executes compute processing operations that are not directly related to graphics operations, such as operations related to video, physics simulations, computational fluid dynamics, or other tasks, based on commands received from the processor 102.

The APD 116 includes compute units 132 that include one or more parallel processing unit 138 that perform operations at the request of the processor 102 in a parallel manner according to a parallel processing paradigm, such as SIMD or SIMT. In such paradigms, multiple processing elements execute the same instruction across multiple data elements or threads. The multiple processing elements share a single program control flow unit and program counter and thus execute the same program but are able to execute that program with or using different data. In one example, each parallel processing unit 138 includes sixteen lanes, where each lane executes the same instruction at the same time as the other lanes in the parallel processing unit138 but can execute that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow.

The basic unit of execution in compute units 132 is a work-item. Each work-item represents a single instantiation of a program or kernel that is to be executed in parallel according to the parallel processing paradigm employed. For example, in a SIMD architecture, multiple work-items execute the same instruction simultaneously on different data elements. Work-items can be executed simultaneously as a “wavefront” on a parallel processing unit 138, where each work-item executes the same instruction with different data and where different work-items can execute a different control flow path through the use of predication. In a SIMT architecture, work-items correspond to threads that can be executed simultaneously on the parallel processing unit 138, where different threads can execute different control flow paths. Threads are grouped into “warps” or “wavefronts”, which are scheduled or executed together.

For the purposes of this description, the term “wavefront” will be used, but it should be understood that this term broadly describes work-items that can be executed simultaneously and is inclusive of both “wavefronts” and “warps.” One or more wavefronts are included in a “work group,” which includes a collection of work-items designated to execute the same program. A work group can be executed by executing each of the wavefronts that make up the work group. In alternatives, the wavefronts are executed sequentially on a single parallel processing unit 138 or partially or fully in parallel on different parallel processing unit 138. Wavefronts can be thought of as the largest collection of work-items that can be executed simultaneously on a single parallel processing unit 138. Thus, if commands received from the processor 102 indicate that a particular program is to be parallelized to such a degree that the program cannot execute on a single parallel processing unit 138 simultaneously, then that program is broken up into wavefronts which are parallelized on two or more parallel processing units 138 or serialized on the same parallel processing unit 138 (or both parallelized and serialized as needed). A scheduler 136 performs operations related to scheduling various wavefronts on different compute units 132 and parallel processing units 138.

The parallelism afforded by the compute units 132 is suitable for graphics related operations such as pixel value calculations, vertex transformations, and other graphics operations and non-graphics operations (sometimes known as “compute” operations). Thus in some instances, a graphics pipeline 134, which accepts graphics processing commands from the processor 102, provides computation tasks to the compute units 132 for execution in parallel.

The compute units 132 are also used to perform computation tasks not related to graphics or not performed as part of the “normal” operation of a graphics pipeline 134 (e.g., custom operations performed to supplement processing performed for operation of the graphics pipeline 134). An application 126 or other software executing on the processor 102 transmits programs that define such computation tasks to the APD 116 for execution.

A local data share 137 is present in each of the compute units 132. Each local data share 137 is accessible to the compute unit 132 that it is in and is not accessible to any other compute unit 132. A global APD memory 139 is global within the APD 116 and is accessible to each compute unit 132. In some examples, the local data share 137 has “better” access characteristics (e.g., lower latency and/or higher bandwidth) than the APD memory 139.

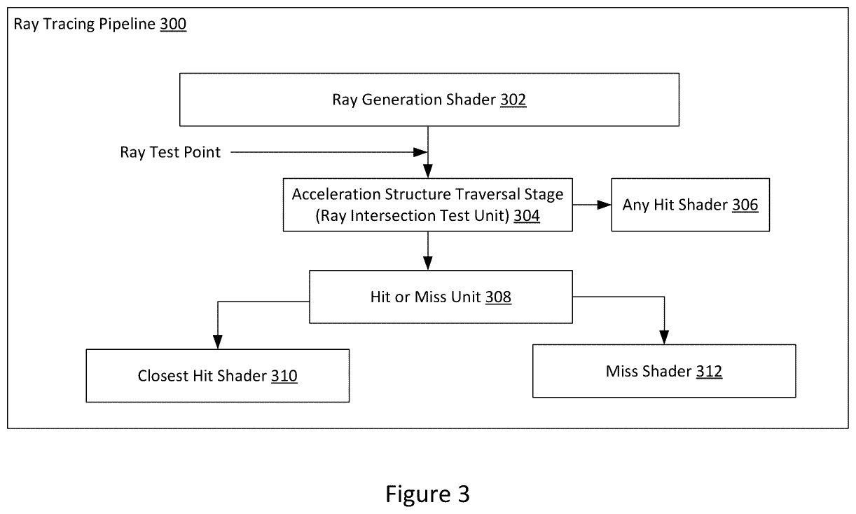

FIG. 3 illustrates a ray tracing pipeline 300 for rendering graphics using a ray tracing technique, according to an example. The ray tracing pipeline 300 provides an overview of operations and entities involved in rendering a scene utilizing ray tracing. A ray generation shader 302, any hit shader 306, closest hit shader 310, and miss shader 312 are shader-implemented stages that represent ray tracing pipeline stages whose functionality is performed by shader programs executing in the SIMD unit 138. Any of the specific shader programs at each particular shader-implemented stage are defined by application-provided code (i.e., by code provided by an application developer that is pre-compiled by an application compiler and/or compiled by the driver 122). The acceleration structure traversal stage 304 performs a ray intersection test to determine whether a ray hits a triangle.

The various programmable shader stages (ray generation shader 302, any hit shader 306, closest hit shader 310, miss shader 312) are implemented as shader programs that execute on the SIMD units 138. The acceleration structure traversal stage 304 is implemented in software (e.g., as a shader program executing on the SIMD units 138), in hardware, or as a combination of hardware and software. The hit or miss unit 308 is implemented in any technically feasible manner, such as as part of any of the other units, implemented as a hardware accelerated structure, or implemented as a shader program executing on the SIMD units 138. The ray tracing pipeline 300 may be orchestrated partially or fully in software or partially or fully in hardware, and may be orchestrated by the processor 102, the scheduler 136, by a combination thereof, or partially or fully by any other hardware and/or software unit. The term “ray tracing pipeline processor” used herein refers to a processor executing software to perform the operations of the ray tracing pipeline 300, hardware circuitry hard-wired to perform the operations of the ray tracing pipeline 300, or a combination of hardware and software that together perform the operations of the ray tracing pipeline 300.

The ray tracing pipeline 300 operates in the following manner. A ray generation shader 302 is executed. The ray generation shader 302 sets up data for a ray to test against a triangle and requests the acceleration structure traversal stage 304 test the ray for intersection with triangles.

The acceleration structure traversal stage 304 traverses an acceleration structure, which is a data structure that describes a scene volume and objects (such as triangles) within the scene, and tests the ray against triangles in the scene. In various examples, the acceleration structure is a bounding volume hierarchy. The hit or miss unit 308, which, in some implementations, is part of the acceleration structure traversal stage 304, determines whether the results of the acceleration structure traversal stage 304 (which may include raw data such as barycentric coordinates and a potential time to hit) actually indicates a hit. For triangles that are hit, the ray tracing pipeline 300 triggers execution of an any hit shader 306. Note that multiple triangles can be hit by a single ray. It is not guaranteed that the acceleration structure traversal stage will traverse the acceleration structure in the order from closest-to-ray-origin to farthest-from-ray-origin. The hit or miss unit 308 triggers execution of a closest hit shader 310 for the triangle closest to the origin of the ray that the ray hits, or, if no triangles were hit, triggers a miss shader.

Note, it is possible for the any hit shader 306 to “reject” a hit from the ray intersection test unit 304, and thus the hit or miss unit 308 triggers execution of the miss shader 312 if no hits are found or accepted by the ray intersection test unit 304. An example circumstance in which an any hit shader 306 may “reject” a hit is when at least a portion of a triangle that the ray intersection test unit 304 reports as being hit is fully transparent. Because the ray intersection test unit 304 only tests geometry, and not transparency, the any hit shader 306 that is invoked due to a hit on a triangle having at least some transparency may determine that the reported hit is actually not a hit due to “hitting” on a transparent portion of the triangle. A typical use for the closest hit shader 310 is to color a material based on a texture for the material. A typical use for the miss shader 312 is to color a pixel with a color set by a skybox. It should be understood that the shader programs defined for the closest hit shader 310 and miss shader 312 may implement a wide variety of techniques for coloring pixels and/or performing other operations.

A typical way in which ray generation shaders 302 generate rays is with a technique referred to as backwards ray tracing. In backwards ray tracing, the ray generation shader 302 generates a ray having an origin at the point of the camera. The point at which the ray intersects a plane defined to correspond to the screen defines the pixel on the screen whose color the ray is being used to determine. If the ray hits an object, that pixel is colored based on the closest hit shader 310. If the ray does not hit an object, the pixel is colored based on the miss shader 312. Multiple rays may be cast per pixel, with the final color of the pixel being determined by some combination of the colors determined for each of the rays of the pixel. As described elsewhere herein, it is possible for individual rays to generate multiple samples, which each sample indicating whether the ray hits a triangle or does not hit a triangle. In an example, a ray is cast with four samples. Two such samples hit a triangle and two do not. The triangle color thus contributes only partially (for example, 50%) to the final color of the pixel, with the other portion of the color being determined based on the triangles hit by the other samples, or, if no triangles are hit, then by a miss shader.

It is possible for any of the any hit shader 306, closest hit shader 310, and miss shader 312, to spawn their own rays, which enter the ray tracing pipeline 300 at the ray test point. These rays can be used for any purpose. One common use is to implement environmental lighting or reflections. In an example, when a closest hit shader 310 is invoked, the closest hit shader 310 spawns rays in various directions. For each object, or a light, hit by the spawned rays, the closest hit shader 310 adds the lighting intensity and color to the pixel corresponding to the closest hit shader 310. It should be understood that although some examples of ways in which the various components of the ray tracing pipeline 300 can be used to render a scene have been described, any of a wide variety of techniques may alternatively be used.

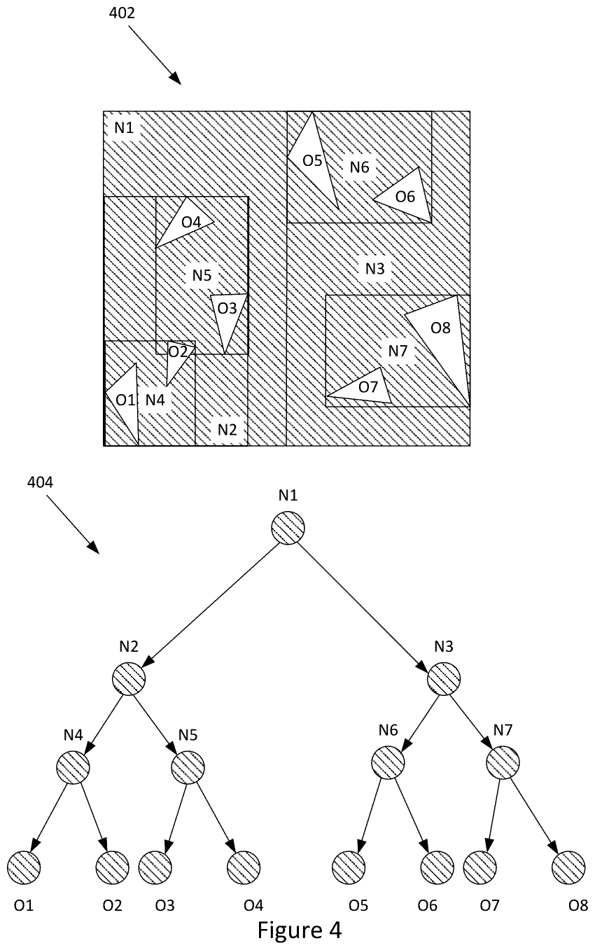

FIG. 4 is an illustration of a bounding volume hierarchy, according to an example. For simplicity, the hierarchy is shown in 2D. However, extension to 3D is simple, and it should be understood that the tests described herein would generally be performed in three dimensions.

The spatial representation 402 of the bounding volume hierarchy is illustrated in the left side of FIG. 4 and the tree representation 404 of the bounding volume hierarchy is illustrated in the right side of FIG. 4. The non-leaf nodes are represented with the letter “N” and the leaf nodes are represented with the letter “O” in both the spatial representation 402 and the tree representation 404. A ray intersection test would be performed by traversing through the tree 404, and, for each non-leaf node tested, eliminating branches below that node if the test for that non-leaf node fails. In an example, the ray intersects O₅ but no other triangle. The test would test against N₁, determining that that test succeeds. The test would test against N₂, determining that the test fails (since O₅ is not within N₁). The test would eliminate all sub-nodes of N₂ and would test against N₃, noting that that test succeeds. The test would test N₆ and N₇, noting that N₆ succeeds but N₇ fails. The test would test O₅ and O₆, noting that O₅ succeeds but O₆ fails. Instead of testing 8 triangle tests, two triangle tests (O₅ and O₆) and five box tests (N₁, N₂, N₃, N₆, and N₇) are performed.

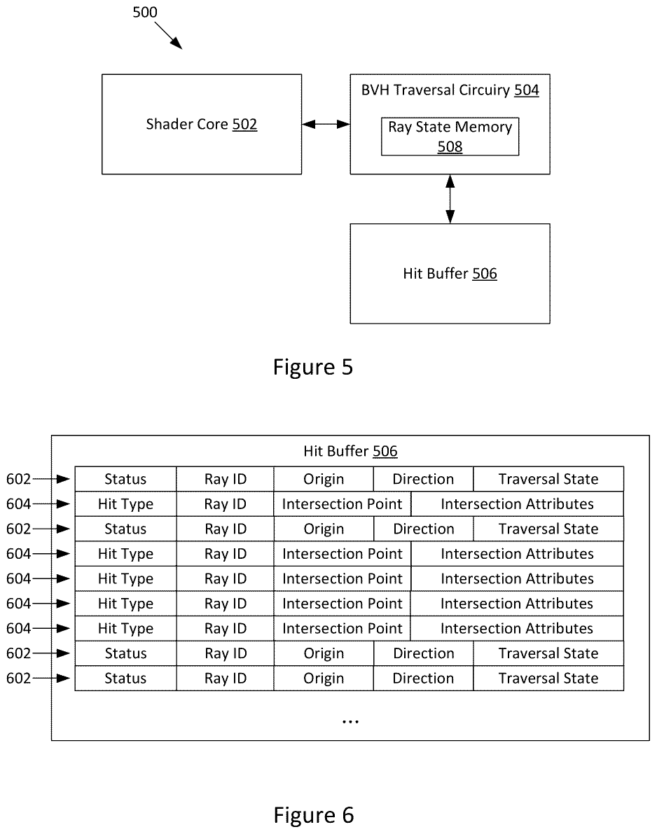

FIG. 5 is a block diagram of a system 500 for performing ray tracing, according to an example. As shown, the system 500 includes a shader core 502, BVH traversal circuitry 504, and a hit buffer 506. The shader core 502 is a programmable processor capable of and configured to execute shader programs. In some examples, the shader core 502 is one or more parallel processing units 138 of FIG. 2. The BVH traversal circuitry 504 is circuitry (e.g., digital circuitry) that is configured to traverse a BVH at the request of the shader core 502, and to perform other related operations. The hit buffer 506 is a buffer in memory (such as in APD memory 139 or in memory 104) that stores certain information for operations for traversal of the BVH performed by the BVH traversal circuitry 504.

In operation, the shader core 502 executes shader programs. Some such shader programs generate a ray (including, e.g., an origin and direction for the ray), and submits such rays to the BVH traversal circuitry 504 for traversal of a BVH with that ray. Traversal of a BVH for a ray involves traversing through the structure of the BVH, following non-leaf nodes intersected by the ray and not following non-leaf nodes that are not intersected by the ray. Traversal of a BVH typically involves execution of mid-traversal work by the shader core 502. In an example, the BVH traversal circuitry 504 determines that a ray intersects a particular primitive associated with a leaf node. This intersection triggers an any hit shader to perform work. In an example, the hit detected by the BVH traversal circuitry 504 is considered a “candidate hit” that may or may not be an actual hit. In this situation, the any hit shader is invoked to determine whether this candidate hit is accepted as an actual hit. While any technically feasible technique can be used to make this determination, in one example, the any hit shader checks whether the primitive for which the candidate hit occurs is opaque (rather than non-opaque) at the point where the intersection occurs. The any hit shader is not limited to determining whether a candidate hit is an actual hit and can perform other work. In another example, a primitive is marked as requiring an intersection shader to determine whether a ray intersects a primitive. An intersection shader is procedurally defined leaf node geometry. In other words, rather than having some statically defined geometry, an intersection shader defines the geometry of a primitive procedurally-executing the intersection shader indicates whether a ray intersects that geometry and thus implicitly and procedurally defines the geometry. In some examples, one difference between an intersection shader and an any hit shader is that for an any hit shader, the primitive is assumed to be a triangle, and thus the any hit shader is invoked in response to the ray intersecting that triangle. For an intersection shader, the BVH traversal circuitry 504 invokes the intersection shader when the bounding volume of the leaf node is determined to be intersected, but no test for intersection with a triangle is performed. Such a test is not performed because the geometry of a leaf node with a primitive marked as needing an intersection shader is not necessarily a triangle and can be any geometry. These are just some examples of work that can be performed in the middle of traversal of a BVH.

The BVH traversal circuitry 504 traverses through a BVH for a ray, performing requested work until a termination condition is met. Note that the intermediate work described above-such as executing an any hit shader or an intersection shader in some instances does not terminate traversal through the BVH. In various examples, the BVH traversal circuitry 504 continues traversal even while such intermediate work is being performed or pauses traversal while such work is being performed. There are a variety of termination conditions. In one example, a termination condition is that there are no more nodes left to traverse. In other words, the BVH traversal circuitry 504 has visited every node not eliminated from consideration for some reason such as due to the ray not intersecting a bounding box (and thus eliminating from consideration the children of that bounding box). In some such examples, the BVH traversal circuitry 504 maintains a set of nodes that are still to be considered. In such examples, the BVH traversal circuitry 504 begins with an entry in that set corresponding to the root node. When the BVH traversal circuitry 504 determines that a ray intersects a bounding box (such as a bounding box included within the root node or another non-leaf node), the BVH traversal circuitry 504 places the node corresponding to that bounding box into the set. When the BVH traversal circuitry 504 tests the ray for intersection with a node in the set, the BVH traversal circuitry 504 removes that node from the set. In this way, the BVH traversal circuitry 504 maintains a set of nodes to be tested for intersection. In such an example, the termination condition occurs when that set is empty. In some examples, a termination condition is that a closest hit has been found and no other work is required for the traversal (e.g., no other any hit shaders are required to be executed). Any of a variety of other termination conditions may be used by the BVH traversal circuitry 504.

One output of the BVH traversal circuitry 504 is information about hits that occur. More particularly, the BVH traversal circuitry 504 detects a hit (such as a hit with a primitive that requires an any hit shader or any other shader to be performed) for a ray and places a hit buffer entry into the hit buffer 506. Such an action allows the BVH traversal circuitry 504 to continue other work. For example, instead of maintaining information about a hit in the BVH traversal circuitry 504 and waiting for the shader core 502 to retrieve that information (e.g., to perform an any hit shader), the BVH traversal circuitry 504 can continue performing other work and the shader core 502 can obtain the information from the hit buffer 506 at some later time.

The ray state memory 508 is memory internal to the BVH traversal circuitry 504 that stores working information about rays being processed by the BVH traversal circuitry 504. In an example, the ray state memory 508 has space for a fixed number of ray state entries. In an example, each ray state entry stores information about one ray, such as a ray identifier, a ray origin, a ray direction, and a minimum and maximum distance for the ray (which limit possible hits for the ray to within that minimum and maximum distance from the origin). In some examples, a ray state entry stores information about the status of traversal through the BVH. In some examples, this status includes the contents of the set of nodes to be visited (e.g., the set formed as described above, where nodes associated with bounding boxes intersected by a ray are stored into a set and nodes that are tested for intersection with a ray are removed from a set).

As can be seen, the ray state memory 508 stores working state for rays being processed by the BVH traversal circuitry 504. It is possible for the limited size of the ray state memory 508 to starve the BVH traversal circuitry 504 of work in certain circumstances. More specifically, where the ray state memory 508 has a smaller number of entries than the number of rays that can be processed in parallel (e.g., that are considered “alive”) in the compute unit 132, such starvation can occur. In some examples, each compute unit 132 has one BVH traversal circuitry 504 and one ray state memory 508, and the ray state memory 508 has a number of slots in it (where each slot stores information for one ray) that is less than the number of rays that can be being processed in parallel in the compute unit 132. Rays that have started being processed in the BVH traversal circuitry 504 and that have not yet reached their termination condition for terminating traversal in the BVH traversal circuitry 504 are called “outstanding rays.” In one example sequence of operations, the shader core 502 has, over time, requested BVH traversal for a number of rays in a manner that the ray state memory 508 is full, meaning that the number of outstanding rays is equal to the number of slots in the ray state memory 508. In this scenario, if the shader core 502 requested traversal for an additional ray, the BVH traversal circuitry 504 would not be able to process that ray (note that in some instances, the shader core 502 waits until a full set (e.g., the width of a wavefront) of slots in the traversal circuitry 504 are available before requesting traversal). This is true even if there are outstanding rays that the BVH traversal circuitry 504 is not currently performing any work for. For example, it is possible that the BVH traversal circuitry 504 has requested mid-traversal shader work (e.g., an any hit shader) to be performed by the shader core 502 for an outstanding ray. In this instance, the BVH traversal circuitry 504 is not performing any work for the outstanding ray, as a return from the shader core 502 is needed to continue for that ray. However, because that ray occupies a slot in the ray state memory 508, there are at least some resources in the BVH traversal circuitry 504 (e.g., logic units for traversing the BVH) that are unused. This period of idleness can extend until even after the requested work on the shader core 502 is completed, because of scheduling latency that can occur. In an example, a work-item in the shader core 502 has generated a ray for submission to the BVH traversal circuitry 504 but has learned that the ray state memory 508 is full and thus has not submitted the ray to the BVH traversal circuitry 504 and has instead been placed into a waiting state. When a slot in the ray state memory 508 becomes available (e.g., because a ray has terminated traversal), the work-item in the waiting state still must be woken up to request that its ray should be processed by the BVH traversal circuitry 504. However, the scheduling algorithm may not wake up the waiting work-item for some time after the slot becomes available in the ray state memory 508, and may need to wait for multiple slots to be free to submit the whole wave of rays. Thus, in that situation, the BVH traversal circuitry 504 would be starved for work. It should be understood that the ray state memory 508 is size-limited because die area is a critical resource and therefore the ray state memory 508 may not be sized to be able to store every ray that could possibly be outstanding.

For the above reasons, in some examples, the BVH traversal circuitry 504 “overflows” rays that cannot fit into the ray state memory 508 into the hit buffer 506. Use of the hit buffer 506 in this manner allows more rays that are being processed in the shader core 502 to be outstanding in the BVH traversal circuitry than the number of slots in the ray state memory 508. In general, in the event that work for a ray is sent by the shader core 502 to the BVH traversal circuitry 504 and there is no space in the ray state memory 508 for that work, the BVH traversal circuitry 504 overflows such work into the hit buffer 506. This overflow can occur in a variety of situations. In one example, the shader core 502 generates a ray for processing and requests the BVH traversal circuitry 504 to traverse the BVH for that ray. In this example, the ray state memory 508 is completely occupied with information for rays. For this reason, the BVH traversal circuitry 504 places the information for the newly received ray into the hit buffer 506. At a subsequent time, when at least one slot in the ray state memory 508 is available, the BVH traversal circuitry 504 fetches the information for the ray from the hit buffer 506 and begins traversal of the BVH for that ray. In another example, the BVH traversal circuitry 504 arrives at a point for a ray that requires mid-traversal shading work (e.g., an any hit shader). In this example, the BVH traversal circuitry 504 cannot perform any more traversal work for that ray until the mid-traversal shading work is complete. In addition, in this example, the ray state memory 508 is full. In this situation, the BVH traversal circuitry 504 evicts the entry for that ray from the ray state memory 508 into the hit buffer 506. At a subsequent time, when the mid-traversal shading work is complete and there is a free slot in the ray state memory 508, the BVH traversal circuitry 504 fetches the information for the ray from the hit buffer 506 into the ray state memory 508.

In summary, to prevent starvation of work in the BVH traversal circuitry 504, the BVH traversal circuitry 504 overflows information for rays into the hit buffer 506. Storing this information in the hit buffer 506 prevents the work-item processing the ray in the shader core 502 from being placed into a waiting state and the resultant latency and delays associated therewith. This overflow can occur in a scenario in which the shader core 502 has generated a ray and requested traversal for that ray, but there are no free slots in the ray state memory 508 to store info for that ray, or can occur in a scenario in which the shader core 502 has completed mid-traversal work for the ray, meaning that the BVH traversal circuitry 504 now needs to continue traversal for that ray, but in which the ray has been evicted from the ray state memory 508. The BVH traversal circuitry 504 opportunistically fetches work from the hit buffer 506 to perform traversal for as slots become freed in the ray state memory 508. In some examples, the BVH traversal circuitry 504 prioritizes rays that have already started traversal through the BVH over new rays received from the shader core 502. A slot is freed from the ray state memory 508 when the BVH traversal circuitry 504 completes traversal for a ray with state in the ray state memory 508 or when the BVH traversal circuitry 504 evicts a ray from the ray state memory 508 in conjunction with requesting the shader core 502 perform mid-traversal work.

FIG. 6 is an illustration of a hit buffer 506, according to an example. The hit buffer 506 is a buffer in memory (e.g., in the memory 104 or the APD memory 139). In some examples, the hit buffer 506 is sized to store a number of entries at least equal to the number of rays that can be concurrently processed in a compute unit 132. Each entry in the hit buffer 506 can be a hit data entry 604 or a ray status entry 602. A hit data entry 604 stores data about hits against primitives detected by the BVH traversal circuitry 504. As described above, these entries buffer information for a shader program so that this information does not need to be retained in the BVH traversal circuitry 504.

Hit data entries 604 are illustrated in the hit buffer 506 of FIG. 6. Again, the BVH traversal circuitry 504 writes a hit data entry 604 into the hit buffer 506 in the event that the BVH traversal circuitry 504 detects a hit between a ray and a primitive. Subsequent to being written, a shader core 502 reads the hit data entry 604 to perform appropriate work, such as mid-traversal shader work (e.g., an any hit shader or an intersection shader) or work at the end of traversal (such as a closest hit shader). Each hit data entry 604 includes a hit type, a ray identifier (“ID”), an intersection point, and intersection attributes. The hit type indicates what type of hit, such as any hit, closest hit, candidate hit for intersection shader, or any other type of hit. The ray ID uniquely identifies the ray that the hit data entry 604 is for. The intersection point indicates the geometric point at which the hit occurs and the primitive with which the hit occurs. The intersection attributes include additional data (such as user-defined data) useful for the hit.

Ray status entries 602 are also illustrated in the hit buffer 506 of FIG. 6. These entries are written into the hit buffer 506 in several circumstances. In one example, the shader core 502 provides a new ray, including appropriate data, to the BVH traversal circuitry 504 for traversal. The ray state memory 508 does not have an empty slot to store the required data for that ray. As a result, the BVH traversal circuitry 504 stores the data for the ray into a ray status entry 602 in the hit buffer 506. In another example, the shader core 502 “returns” data from mid-traversal shader work and there are no free slots int he ray state memory 508. Asa result, the BVH traversal circuitry 504 stores a ray status entry 602 into the hit buffer 506 for that ray, to be examined and used at a later time. In another example, the BVH traversal circuitry 504 has requested that the shader core 502 perform mid-traversal work and, as a result, as paused traversal for that ray. As a result, the BVH traversal circuitry 504 decides to “evict” the ray from the ray state memory 508 so that the slot for that ray can be used for another ray. In some examples, the BVH traversal circuitry 504 does not necessarily evict all rays for which mid-traversal work is requested. Instead, in some examples, the BVH traversal circuitry 504 considers one or more factors to determine whether to perform such eviction. In one example, when the number of empty slots in the ray state memory 508 is below a threshold when the BVH traversal circuitry 504 determines that mid-traversal work is requested, the BVH traversal circuitry 504 evicts the ray for which such work is requested. In another example, mid-traversal shader work is being performed for a ray and no BVH traversal work is being performed for that ray, and the data for the ray is still stored in the ray state memory 508 (e.g., because the BVH traversal circuitry 504 determined not to evict that data previously). In this example, the ray state memory 508 becomes full (has no empty slots, e.g., due to additional work coming in to the BVH traversal circuitry 504) and the shader core 502 transmits new traversal work to the BVH traversal circuitry 504. Because there is a slot in the ray state memory 508 that is occupied but not in use, the BVH traversal circuitry 504 evicts that ray to the hit buffer 506, providing space for the new work. In various examples, this new work is a request to traverse a BVH for a new ray or is a request to continue traversal for a ray for which mid-traversal shader work has completed in the shader core 502.

In an example, each ray status entry 602 includes a status, a ray ID, an origin, a direction, and a traversal state. The status indicates the status of the ray in terms of what traversal work is to be performed next and/or what shader core work needs to be performed next. In an example, a new ray received from the shader core 502 and stored into the hit buffer 506 has a status indicating that the ray needs to begin traversal of the BVH. In an example, a ray has been returned from mid-traversal work for the shader core 502, and an entry for that ray has been stored into the hit buffer 506. The status for this ray would indicate that the BVH traversal circuitry 504 should resume traversal of the BVH for that ray. Other statuses include what action to take on the candidate hit that was passed to the shader for any hit shader evaluation, whether the hit is accepted or rejected, and whether to continue or terminate traversal. The ray ID indicates a ray identifier for the ray corresponding to the ray status entry 602. The origin indicates the origin of the ray. The direction indicates the direction of the ray. The traversal state indicates the progress through the BVH for that ray. In some examples, the traversal state includes the set of nodes for which it has been determined that these nodes are to be traversed to, but that have not yet been traversed to. In some examples, the ray status entry 602 also includes the “tmax” and “tmin” for the ray, where these values define a range of distances (from tmin to tmax) from the ray origin at which it is possible for hits to occur (e.g., no intersection can occur closer to the origin than tmin or farther from the origin than tmax).

In some examples, each ray status entry 602 occupies the same amount of space as each hit data entry 604. In some examples, the hit buffer 506 is a pre-allocated buffer that is sized to fit a certain number of such entries (either ray status entries 602 or hit data entries 604). In some examples, the BVH traversal circuitry 504 is able to use the space from one ray status entry 602 as a hit data entry 604 after the ray status entry 602 is no longer in use, or is able to use a hit data entry 604 as a ray status entry 602 after the hit data entry 604 is no longer in use. In some examples, a ray status entry 602 is no longer in use when the BVH traversal circuitry 504 reads the data from that ray status entry 602 to begin or continue traversal for the corresponding ray. In some examples, a hit data entry 604 is no longer in use when the shader core 502 reads that hit data entry 604 for processing.

As stated above, in some examples, the BVH traversal circuitry 504 writes a ray status entry 602 into the hit buffer 506 in a variety of circumstances. Subsequently, the BVH traversal circuitry 504 reads that ray status entry 602 for use (e.g., for traversal). In some examples, even though the buffer 506 is a buffer in memory, the BVH traversal circuitry 504 attempts to maintain the entries in the cache system. More particularly, when the BVH traversal circuitry 504 stores an entry into the hit buffer 506, that entry is first stored into a cache such as an L0 cache, without being immediately written out to memory. In some examples, when the BVH traversal circuitry 504 subsequently reads that entry for use, the BVH traversal circuitry 504 does so with a “read for last use” memory access request. This request causes the cache line(s) containing the entry to invalidate the line after returning the line to the BVH traversal circuitry 504. This invalidation prevents the line from being written out to higher level caches or to memory. These operations cause the entries to be stored in the cache without being written out to memory, thereby reducing the amount of memory traffic consumed. In addition, these entries are not written out to higher cache levels, meaning that the capacity for those higher level memories is not needlessly consumed.

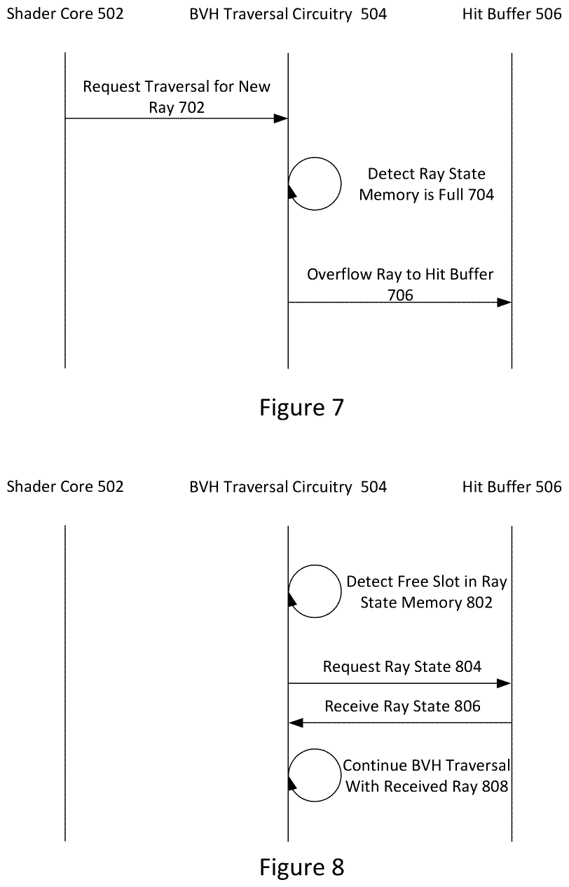

FIGS. 7-9 illustrate example operations for utilizing the hit buffer 506 to overflow ray data. FIG. 7 illustrates an operation in which the shader core 502 sends a ray to the BVH traversal circuitry 504 for traversal of the BVH, but the ray state memory 508 is full. As can be seen, at operation 702, the shader core 502 provides a ray to the BVH traversal circuitry 504 along with a request to traverse the BVH for that ray. As described elsewhere herein, the request to traverse for that ray is a search for which primitives are intersected by the ray, which then, in many instances, triggers subsequent work such as execution of various shader work. In the instance of FIG. 7, the BVH traversal circuitry 504 receives such a request and detects that the ray state memory 508 is full (has no empty slots) at operation 704. This means that the information for the newly received ray cannot be stored into the ray state memory 508. For this reason, at step 706, the BVH traversal circuitry 504 stores that information as a ray status entry 602 into the hit buffer 506. Although operation 702 indicates that a request is for traversal for a new ray, in some examples, this request is for continuation of traversal for a return from the shader core 502.

FIG. 8 illustrates an operation in which the BVH traversal circuitry 504 fetches ray state from the hit buffer 506. In this operation, at operation 802, the BVH traversal circuitry 504 detects a free slot in the ray state memory 508. This free slot means that there is space in the ray state memory 508 for another ray for BVH traversal. A slot can become free in the event that a ray is evicted from the ray state memory 508 into the hit buffer 506 for a reason described elsewhere herein or in the event that BVH traversal has completed for that ray and thus results have been returned to the shader core 502 (e.g., via the hit buffer 506 storing a hit data entry 604). As a result, at operation 804, the BVH traversal circuitry 504 requests ray state from the hit buffer 506. The BVH traversal circuitry 504 may apply a selection scheme such as oldest first, to select one of the ray status entries 602 (e.g., to select the oldest ray in the hit buffer 506) or may select a ray in any technically feasible manner. At operation 806, the hit buffer 506 returns the information for the requested ray. At operation 808, the BVH traversal circuitry 504 continues with BVH traversal with the retrieved ray, for which an entry is now stored in the ray state memory 508.

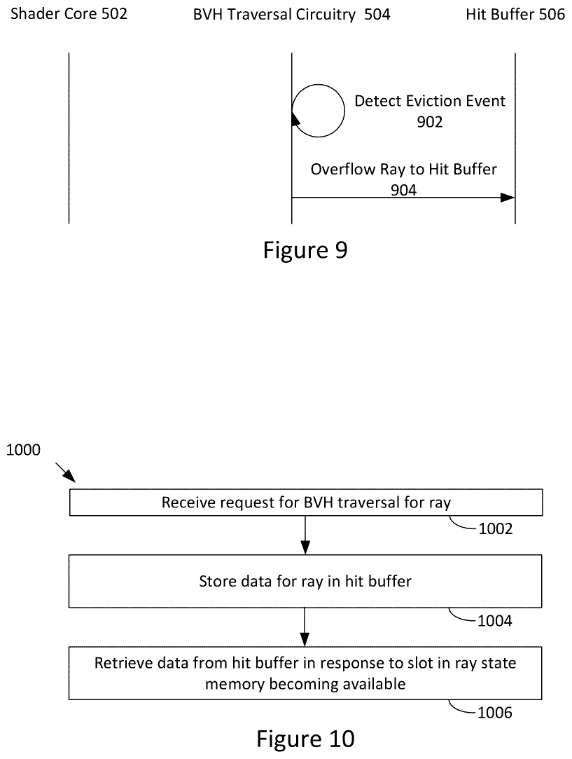

FIG. 9 illustrates an operation in which the BVH traversal circuitry 504 evicts a ray to the hit buffer 506. In operation 902, the BVH traversal circuitry 504 detects an eviction event. In one example, an eviction event occurs when the BVH traversal circuitry 504 requests the shader core 502 to perform mid-traversal shader work. In another example, an eviction event occurs for a ray when the ray is paused in the BVH traversal circuitry 504 but additional rays are received by the BVH traversal circuitry 504, where such rays are ready to be processed but there are no free slots. In another example, an eviction event occurs for a ray when the ray is paused in the BVH traversal circuitry 504 and the number of free slots in the ray state memory 508 drops below a threshold. In another example, an eviction event occurs when work being performed in the BVH traversal circuitry 504 is pre-empted (e.g., in a preemptive multitasking task switch). In operation 904, the BVH traversal circuitry 504 overflows the ray to the hit buffer 506.

In summary, the BVH traversal circuitry 504 utilizes the hit buffer 506 to store ray status entries 602 in certain circumstances. In particular, if the shader core 502 requests traversal of the BVH for a ray (or returns from mid-traversal shading work), and the ray state memory 508 is full, the BVH traversal circuitry 504 overflows the ray data to the hit buffer 506 as a ray status entry 602. The BVH traversal circuitry 504 also overflows rays into the hit buffer 506 when an eviction event occurs (as described elsewhere herein). The BVH traversal circuitry 504 observes the status of the ray state memory 508, including whether there are available slots, and fetches entries from the hit buffer 506 as entries become available in the ray state memory 508, for further traversal. In practice, this means that rays not being processed in the BVH traversal circuitry 504, for example, due to mid-traversal work being performed for such rays, the slot(s) occupied by such rays can be reused for other rays. Additionally, the shader core 502 is not forced to wait for an available slot in the ray state memory 508 before sending a ray to the BVH traversal circuitry 504 for processing, as if the ray state memory 508 is full, the BVH traversal circuitry 504 stores a new ray into the hit buffer 506. These features alleviate the issues related to starvation of work in the BVH traversal circuitry 504.

FIG. 10 is a flow diagram of a method 1000 for performing ray tracing work, according to an example. Although described with respect to the system of FIGS. 1-9, those of skill in the art will understand that any system configured to perform the steps of the method 1000 in any technically feasible order falls within the scope of the present disclosure.

At step 1002, the BVH traversal circuitry 504 receives a request to traverse the BVH for a ray. This request can be for a newly generated ray (e.g., generated by a ray generation shader) or can be for a ray for which mid-traversal work has been requested and completed. At step 1004, the BVH traversal circuitry 504 detects that the ray state memory 508 is full and therefore stores the ray data into the hit buffer 506. At step 1006, the BVH traversal circuitry 504 detects that a slot has become free in the ray state memory 508 and therefore performs the work stored into the hit buffer 506.

As part of the method 1000, any of the steps of the operations in FIGS. 7-9 can be performed. For example, it is possible for the BVH traversal circuitry 504 to evict one or more items of ray data into the hit buffer 506 as described with respect to FIG. 9. In some examples, this eviction occurs for rays other than the rays for which steps 1002-1006 are performed. In another example, the BVH traversal circuitry 504 detects a free slot in the ray state memory 508 and fetches one or more rays from the hit buffer 506 to traverse the BVH for.

In addition, the hit buffer 506 is also used to store hit data entries 604. Thus, in some examples, the BVH traversal circuitry 504 stores a ray status entry 602 into a slot in the hit buffer 506 that was previously used as a hit data entry 604. In some examples, the BVH traversal circuitry 504 stores a hit data entry 604 into a slot in the hit buffer 506 that was previously used as a ray status entry 602.

It should be understood that many variations are possible based on the disclosure herein. Although features and elements are described above in particular combinations, each feature or element can be used alone without the other features and elements or in various combinations with or without other features and elements.

The various functional units illustrated in the figures and/or described herein (including, but not limited to, the processor 102, auxiliary devices 106, the accelerated processing device 116, the input/output devices 117, the scheduler 136, the compute units 132, the parallel processing units 138, the ray tracing pipeline 300, including the ray generation shader 302, acceleration structure traversal stage 304, any hit shader 306, hit or miss unit 308, closest hit shader 310, the miss shader 312, or the shader core 502, may be implemented as a general purpose computer, a processor, a processor core, or in digital circuitry or analog circuitry, or as a program, software, or firmware, stored in a non-transitory computer readable medium or in another medium, executable by a general purpose computer, a processor, or a processor core. Anything described as “circuitry” could be implemented as programmable hardware, or as a program, software, or firmware, stored in a non-transitory computer readable medium or in another medium, executable by a general purpose computer, a processor, or a processor core. The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method for performing ray tracing operations, the method comprising:
receiving a request for bounding volume hierarchy (“BVH”) traversal for a ray;
in response to a ray state memory being full, storing data for the ray into a hit buffer;
in response to at least one entry in the ray state memory being free, retrieving the data for the ray from the hit buffer into the ray state memory; and
traversing the BVH for the ray based on the data for the ray.

2. The method of claim 1, wherein the BVH traversal for the ray includes identifying which primitives of the BVH are intersected by the ray.

3. The method of claim 2, wherein the identifying includes performing mid-traversal shader work.

4. The method of claim 3, wherein performing the mid-traversal shader work comprises:
detecting an intersection of the ray with a primitive;
requesting a shader core to perform mid-traversal shader work for the ray; and
storing an entry into the hit buffer for the ray.

5. The method of claim 4, further comprising retrieving data for the ray from the entry for further BVH traversal for the ray.

6. The method of claim 1, wherein the request for BVH traversal for the ray comprises a request to begin traversal for the ray or a request to continue traversal for the ray.

7. The method of claim 1, wherein the at least one entry in the ray state memory becomes free due to eviction.

8. The method of claim 1, wherein the at least one entry in the ray state memory becomes free due to completion of traversal for the at least one entry.

9. The method of claim 1, wherein the hit buffer also stores hit data entries.

10. A system for performing ray tracing operations, the system comprising:
a memory capable of storing a hit buffer; and
a processor configured to:
receive a request for bounding volume hierarchy (“BVH”) traversal for a ray;
in response to a ray state memory being full, store data for the ray into the hit buffer;
in response to at least one entry in the ray state memory being free, retrieve the data for the ray from the hit buffer into the ray state memory; and
traverse the BVH for the ray based on the data for the ray.

11. The system of claim 10, wherein the BVH traversal for the ray includes identifying which primitives of the BVH are intersected by the ray.

12. The system of claim 11, wherein the identifying includes performing mid-traversal shader work.

13. The system of claim 12, wherein performing the mid-traversal shader work comprises:
detecting an intersection of the ray with a primitive;
requesting a shader core to perform mid-traversal shader work for the ray; and
storing an entry into the hit buffer for the ray.

14. The system of claim 13, wherein the processor is further configured to retrieve data for the ray from the entry for further BVH traversal for the ray.

15. The system of claim 10, wherein the request for BVH traversal for the ray comprises a request to begin traversal for the ray or a request to continue traversal for the ray.

16. The system of claim 10, wherein the at least one entry in the ray state memory becomes free due to eviction.

17. The system of claim 10, wherein the at least one entry in the ray state memory becomes free due to completion of traversal for the at least one entry.

18. The system of claim 10, wherein the hit buffer also stores hit data entries.

19. A non-transitory computer-readable medium storing instructions that, when executed by a processor, cause the processor to perform operations comprising:
receiving a request for bounding volume hierarchy (“BVH”) traversal for a ray;
in response to a ray state memory being full, storing data for the ray into a hit buffer;
in response to at least one entry in the ray state memory being free, retrieving the data for the ray from the hit buffer into the ray state memory; and
traversing the BVH for the ray based on the data for the ray.

20. The non-transitory computer-readable medium of claim 19, wherein the BVH traversal for the ray includes identifying which primitives of the BVH are intersected by the ray.
